(19) United States
(12) Patent Application Publication
(10) Pub. No.: US 2016/0125539 A1
(43) Pub. Date: May 5, 2016

(54) Multifactorial Leveraged Indexed Investment Product

(71) Applicant: Mehmet Alpay Kaya, Indian Shores, FL (US)

(72) Inventor: Mehmet Alpay Kaya, Indian Shores, FL (US)

(21) Appl. No.: 14/532,065

(22) Filed: Nov. 4, 2014

(51) Int. Cl. G06Q 40/06

(52) U.S. Cl. CPC G06Q 40/06

(57) ABSTRACT

A computer-implemented method is presented for structuring and maintaining a leveraged indexed investment product, also known as leveraged exchange-traded fund, leveraged ETF, and LETF. The method comprises determining a leverage adjustment protocol, monitoring the leverage of the product, and calculating a target leverage adjustment in accordance with the protocol. Advantages of one or more embodiments include a longer-term investment return profile improved across different statistical regimes, fewer and smaller rebalancing actions, and no more than a predetermined variation in leverage. The method is compatible with fund structures in which the beneficial interests of investors are fungible.

### FEDERALLY SPONSORED RESEARCH OR DEVELOPMENT

The research and development activities serving as the foundation of the invention were conducted with no Government support.

### CROSS REFERENCE TO RELATED APPLICATIONS

This application does not contain a reference to any other application.

### JOINT RESEARCH AGREEMENT

There is no joint research agreement applicable to the invention. The research and development activities serving as the foundation of the invention were conducted independently by the sole named inventor.

### PRIOR DISCLOSURES BY THE INVENTOR

Prior to this application, the inventor has not disclosed the invention.

### BACKGROUND OF THE INVENTION

The following tabulation lists, in reverse chronological order, prior art among United States patents that appears to be relevant at present.

United States patents

| Document | Issue Date | Inventor |
|---|---|---|
| 8,538,860 B1 | 2013 Sep. 17 | Fonss et al. |
| 8,271,371 B2 | 2012 Sep. 18 | Noma |
| 7,831,497 B2 | 2010 Nov. 09 | O'Neill |

The following tabulation lists, in reverse chronological order, prior art among United States patent applications that appears to be relevant at present.

United States Patent Applications

| Document | Publication Date | Applicant |
|---|---|---|
| 2012/0166326 A1 | 2012 Jun. 28 | Sapir et al. |
| 2011/0191234 A1 | 2011 Aug. 04 | Kiron |

The following tabulation lists, in reverse chronological order, prior art among nonpatent literature that appears to be relevant at present.

### Nonpatent Literature

Kaya, Mehmet Alpay; Leveraged ETFs: How Biased Statistics Affect Your Portfolio; ISBN 9781482593570; 2013.
Avellandeda, Marco and Zhang, Stanley; “Path-Dependence of Leveraged ETF Returns”; SIAM Journal on Financial Mathematics; Society for Industrial and Applied Mathematics; Volume 1, pages 586-603; 2010.
Hill, Joanne and Foster, George; “Understanding Returns of Leveraged and Inverse Funds”; Journal of Indexes; Volume 12, Number 5; 2009.

Working definitions for some specialized terms are provided in the Glossary section.

An indexed investment product (IIP) offers investment exposure to an index. The return objective of an IIP is a function of the series of future returns of its index. Because the value evolution of an IIP is affected by the value evolution of its index, the terms index and underlying index are used interchangeably. For the same reason, an IIP is said to track its underlying index. The method of index specification is not unique, but it is necessary that the specification describe an investment policy.

An index may be identified by name. If the Standard & Poor's 500@equity index is considered as a nonlimiting example, then the return objective of an IIP is determined by the definition of that index and is the series of future investment returns equal to those obtained by purchasing the common stock of that index's constituents in the weightings specified by the publisher of that index with all disbursements reinvested in the same manner. An index need not be limited to a single asset but may be a basket of assets; likewise, an index could be specified as a basket of other indices.

An index may be specified by an itemization of investment actions. If a long position in a foreign exchange currency cross such as Euro versus US Dollar (EUR/USD) is considered as a nonlimiting example, then the return objective of an IIP could be specified as the series of future investment returns equal to those obtained by receiving interest at the Euro rate for a selected term, paying interest at the US Dollar rate for the same term, and initiating a long exposure to the EUR/USD spot exchange rate.

If a short position in a commodity such as crude oil is considered as a nonlimiting example, then the return objective of an IIP could be specified as the series of future investment returns equal to those obtained by initiating a short position in a futures contract with a selected expiration date subject to a selected procedure for exiting the position before delivery and entering a short position in a contract with a selected, later expiration date.

Although financial instruments may be mentioned in the index specification, such language may used for the purpose of describing the return objective without any implied limitations on actualization. Other instruments may be used to provide substantially the same returns. An index may be specified for any asset class. For the purpose of structuring an IIP, the only requirement of its index specification is that it specify an investment policy.

The structures of IIPs vary, including but not limited to those described by the terms mutual fund, exchange-traded fund (ETF), and exchange-traded note (ETN). Traditionally, IIPs have been managed with the objective of providing returns equal to the returns of their underlying indices. Although informally characterized as having no leverage or yielding returns without leverage, they are actually +1× (positive one times) leveraged products. ETFs are used as exemplary +1× IIPs in the present disclosure without acceptance of limitation to the scope of any statement.

Subsequently, IIPs employing leverage multiples other than +1 have been introduced. Products with leverage multiples greater than +1, including but not limited to values equal to one of +2 and +3, are called leveraged funds. Products with a leverage multiple equal to −1 are called inverse funds. Products with leverage multiples less than −1, including but not limited to values equal to one of −2 and −3, are called inverse leveraged funds. In the present disclosure, a leveraged indexed investment product (LIIP) comprises all of these groups (see definition, Paragraph 56). In Finance parlance, an LIIP with positive leverage is long the index, and one with negative leverage is short the index. Many LIIPs are structured similarly to ETFs, and the name leveraged ETF (LETF) has become synonymous with LIIPs. LETFs are used as exemplary LIIPs in the present disclosure without acceptance of limitation to the scope of any statement.

An arithmetic return leveraged system (ARLS) is a system specified by a constraint on its arithmetic return (see definition, Paragraph 53). Every LIIP is an ARLS. ETFs and LETFs are mutually exclusive instantiations of ARLSs. The returns of ETFs are affected by management fees. The returns of LETFs are affected by management fees and financing costs. Both management fees and financing costs are assumed to be zero herein. This assumption supports a full, clear, and concise description without adversely affecting the universality of the present disclosure.

The return objective of an LETF is to provide investors with returns leveraged to the returns of its underlying index over a specified period of time, known as a rebalancing period. As an index changes in value, leverage deviates from its target value. As a nonlimiting example, consider that an investment of 100 units in a +3× LETF offers long exposure to 300 units of an index. If the value of the index increases by 1% in one rebalancing period, the assets of the LETF likewise increase by 1% from 300 to 303 units. The value of the investment increases by 3% from 100 to 103 units. At this point however, LETF assets (303 units) are less than three times the current value of the investment (103 units). Rebalancing is done to adjust the leverage of the fund to the target value specified in the prospectus. The first LETFs had daily return objectives, and LETFs with daily rebalancing (hereinafter Daily LETF) remain the archetype of the sector. Daily should be understood to mean each trading day. It is estimated Daily LETFs represent investor assets under management in excess of forty billion US Dollars.

As time passed, investors noticed a difference between the relative value evolutions of ETFs and Daily LETFs. In a sideways market, the value of an index may be equal to its value at some earlier point in time. When this is the case, the value of an ETF tracking the index is substantially equal to its own value at that same earlier point in time. In this circumstance, the value of a Daily LETF tracking the index is less than its own value at that same earlier point in time. This is the case whether the Daily LETF is long or short the index. Although the values of the index and ETF were unchanged, both long and short Daily LETFs lost value. This loss of value in flat markets became known as value decay.

Investors became apprehensive about the management of Daily LETFs. Analyses of various Daily LETFs showed that the daily return objectives stated in the prospectuses were actualized on a consistent basis. Hypotheses blaming excessive borrowing costs and exorbitant management fees were refuted by simulations showing value decay under the ideal assumptions of zero fees, free credit, and perfect leverage regulation. If only by process of elimination, it became widely accepted that value decay was caused by the act of rebalancing. Nevertheless, it also became clear there was a widespread lack of understanding regarding the long-term value evolution of Daily LETFs. The utility of Daily LETF return objectives was called into question: even if a +2× Daily LETF satisfied its daily return objective, what would be the ratio of its annual return to that of its index? The long-term performance of Daily LETFs relative to their daily return objectives became a research focus.

### Research

Professionals in the LETF industry researching the nature of Daily LETF returns challenge the perception that Daily LETFs manifest a consistent decay in value. Hill and Foster conducted an empirical study on decades of market data, and concluded that on average, Daily LETFs satisfy the return objective over time intervals other than the stated rebalancing period. They found that periods during which Daily LETF returns were higher or lower than index returns scaled by leverage were consistent with increased volatility in the underlying index. They contradict claims that Daily LETFs are inappropriate as long-term holdings, claiming research findings to the contrary focus on “a few periods of extraordinary market volatility.”

Academics in the fields of Finance and Mathematics have modeled Daily LETFs by taking the established Geometric Brownian Motion model for asset pricing under uncertainty and scaling its finite difference equation by leverage. The joint research of Avellaneda and Zhang is representative of the body of work. They found that the future price evolution of an LETF model assuming continuous rebalancing accurately estimates the future price evolution realized by Daily LETFs. Their model indicates that the value decay rate of a Daily LETF equals

Daily LETF Value Decay Rate=½(b−b²)(s(Index))² (EQ. 1)

one-half the quantity leverage b minus its square times the variance rate of the index. The variable s in EQ. 1 is the square-root of the variance rate.

Consider the following nonlimiting example. If an index with log-normally distributed prices has annual period volatility of 20%, then it has a variance rate of 4% per year (=0.22). A +3× Daily LETF tracking the index will have an expected value decay rate of −12% per year (=0.5×(3−3²)×0.04=−3×0.04). If the forward-looking, one-year log return of the index happens to be 5% with 25% annualized volatility, then investors in the +3× Daily LETF will have a one-year log return of −3.75% (=3×0.05−3×0.25²). In such a circumstance, an ETF will have outperformed the Daily LETF even though the index exposure chosen by Daily LETF investors was directionally correct. This sort of situation has left many LETF investors wondering why leverage did not increase return.

In researching LIIPs, I have focused on the definition of leverage itself, showing that a log-normal distribution may be represented as a system with an input, process, and output. Under this framework, the input of the system is equal to logarithmic return. The process is continuous growth at the rate of the differential change of a variable normalized by its contemporaneous value, the solution of which is the exponential function. The output of the system is a growth factor (see definition, Paragraph 54). As ARLSs, all LIIPs (including Daily LETFs) leverage arithmetic return, which is the growth factor subject to a trivial translation change of basis.

I have shown that multiplicative scaling of the input results in a log return leveraged system (LRLS) that serves as a model for a leveraged system free from value decay (see definition, Paragraph 58). Several properties support its use as a reference system. An LRLS will be flat if and only if its index is flat, which is compatible with the common perception of value decay (see Paragraph 17). For any constant value of leverage, the ratio of the log returns of an LRLS to the log returns of its index is invariant over all time intervals and all return series. Finally, an LRLS will have zero value if and only if its index has zero value.

The advantageous properties of an LRLS arise from its definition. By leveraging input, an LRLS has access to future information (even if only by an infinitesimally short period of time). Log leverage in returns is a logical analog to 100% efficiency in energy processes in that it is an idealized benchmark that can never be achieved. My derivation of the price equation and statistical distribution of LRLSs complements the work of others on ARLSs and serve to inform understanding of earlier research by connecting the findings of Avellaneda and Zhang to the findings of Hill and Foster.

Many Finance professionals are unsure of how to view LIIPs. Mathematically motivated research indicates value decay is real. Empirical research on decades of market data acknowledges return ratios may deviate from target leverage temporarily but makes an argument against value decay overall. My research results show that the claims of Hill and Foster are a manifestation of the fact that the mean average value of a log-normal distribution is greater than the median value. As a likely consequence of their empirical framework, they have incorrectly attributed a portion of the variance of return to the mean average of return.

### Products

The knowledge base on the topic of value decay offers no direction on realizing an improved LIIP. This is reflected in the direction taken by the industry with respect to the next generation of products. Almost every new or proposed LIIP is structured to address nothing more than the one example on which there is widespread agreement: if the index is flat, the Daily LETF is down.

One expansion to the LIIP sector is in the form of LETFs with a monthly return constraint (hereinafter Monthly LETF). Since rebalancing has been judged to cause value decay, a longer rebalancing period is presumed to alleviate the problem. There are several disadvantages associated with this approach. The rebalancing action to be taken once a month can be much larger than that for a Daily LETF, and this raises two concerns. Smaller markets can be overwhelmed by the liquidity required for large rebalancing actions. With large, scheduled rebalancing actions also come increased incentives and increased potential for market participants to trade in front of the fund. These are already points of debate with Daily LETFs, and extending the rebalancing interval only magnifies them.

With monthly rebalancing, leverage drift also becomes an issue. Leverage will vary without limit during the course of a month. As a nonlimiting example, consider a −3× Monthly LETF tracking an index, the log returns of which are normal and have zero mean average with 20% annual volatility. Assume investor assets begin at 100 units with index exposure of −300 units (=−3×100). Assuming 252 trading days per year (21 trading days per month), the index has daily volatility of 1.26% (=0.2×252^{-0.5}). If the index deviates by 1.6 standard deviations to the upside over 11 trading days, index exposure will become −320.7 units (=−300 exp(1.6×0.0126×110.5)). Investor assets will fall by 20.7 down to 79.3 units and leverage will change from −3.0 to −4.0 (=−320.7/79.3) with 10 trading days still left in the month. The probability of at least a 1.6 standard deviation move is greater than 10% in a normal distribution. Although leverage deviated from −3 to −4 halfway through the rebalancing period, the rebalancing protocol prohibits any action until the scheduled action at the end of the month.

Negative equity is another problem introduced by monthly rebalancing. Consider the example of a +3× Monthly LETF tracking an index that has lost 35% of its value within the course of a month. In this circumstance, an investment in the fund will have lost 105% of its value, not only wiping out investor equity but creating a liability. This is extremely unlikely within the course of one month; nevertheless, Monthly LETF fund sponsors state that their funds would be rebalanced as necessary to avoid a complete loss of investor assets.

Setting aside the aforementioned disadvantages, Monthly LETFs do not offer any advantage over Daily LETFs. As will be shown later, the longer-term return statistics of Monthly LETFs are substantially the same as those of Daily LETFs. In other words, Monthly LETFs are not genuinely differentiated from Daily LETFs. It is not clear when market participants will realize this fact, and it is for this reason they are most accurately described as an ad hoc solution. Monthly LETFs are not considered in the present disclosure except where explicitly mentioned.

Another expansion to the LIIP sector is in the form of LETFs with a lifetime return constraint (hereinafter Lifetime LETF). These are equivalent to LETFs with infinite rebalancing periods; in other words, no rebalancing. Such products have associated with them the disadvantages of leverage drift and negative equity. With these products however, leverage drift may evolve without limit and the circumstance leading to negative equity is no longer a remote possibility. As a statistical fact, there is zero probability that a Lifetime LETF will never require rebalancing in order avoid a complete loss of investor assets.

Lifetime LETFs have an additional disadvantage. Because these funds seek to offer every investor path-independent returns (excluding rebalancing actions to avoid bankruptcy), the beneficial interests of each investor must be maintained separately. As such, there is no possibility of issuing fungible fund shares. The fungibility of shares, allowing for intraday trading in the open market, is one of the beneficial characteristics of ETFs and Daily LETFs.

The structures of Lifetime LETFs vary but typically include managing for each investor the equivalent of a combination of a cash account and an interest in a Daily LETF (O'Neill, Sapir et al., and Kiron). The goal is to imitate a Lifetime LETF by regulating the index exposure of an investor to that of a Lifetime LETF, which means index exposure is equal to initial index exposure (leverage times initial investor assets) times the growth factor of the index from the time of the initial investment of each investor. This is achieved by rebalancing actions that seek to substantially negate the rebalancing actions of the Daily LETF portfolio manager. The system proposed by Fonss et al. employs a money market fund structure to accomplish the same objective. Regardless of the structure, any system imitating a Lifetime LETF will have the same problematic characteristics.

One exception to the nascent popularity of systems seeking to imitate Lifetime LETFs is the patented system proposed by Noma. The system is designed with the objective of making the ratio of fund return to index return time-invariant. Although the theoretical properties of power functions are presented correctly, implementation of this system would require knowledge of future information in the form of the derivative of the growth factor of the index. Knowing the derivative of the growth factor of the index is equivalent to knowing the instantaneous return rate of the index, which is equivalent to knowing future price action. The inventor acknowledges this logical disconnect but offers no analysis on its negative effects. This system is comparable to the proposition of a machine built ‘such that there are no energy losses’. Since any attempted implementation of this system (even assuming instantaneous transactions and zero transaction costs) will lack the beneficial properties discussed by Noma, it is excluded from further consideration in the present disclosure.

### Mathematics

The current body of LIIPs, regardless of structure or return objective, represents a significant expansion of earlier IIPs. The number of additional leverage choices by which investors may realize index exposure is apparent. Just as noteworthy is that LIIPs also brought about a transformation of IIPs from LRLSs to ARLSs.

An ARLS tracking an index effects a growth factor equal to

y(ARLS(Index,b),tᵢ,tⱼ)=1+ba(Index,tᵢ,tⱼ) (EQ. 2)

positive one plus the product of leverage b and arithmetic return a(•) of the index tracked by the ARLS, where tⱼ−tᵢ is the rebalancing period. An LRLS tracking an index effects a growth factor equal to

y(LRLS(Index,b),tᵢ,tⱼ)=exp(br(Index,tᵢ,tⱼ)) (EQ. 3)

the exponential function of the product of leverage b and logarithmic return r(•) of the index tracked by the LRLS. Since EQ. 3 differs from EQ. 2, simple logic dictates that one should not assume the two leveraged systems have the same properties.

For several decades leading up to the introduction of LETFs in the United States in 2006, IIPs in the form of ETFs offered investors fund returns equal to the returns of an index over any and all time intervals. In other words, the ratio of ETF returns to index returns is time-invariant. Based on decades of first-hand experience, many investors assumed LETF returns would be time-invariant also. Of course, recent experience has shown otherwise.

The ARLS growth factor from EQ. 2 may be written

y(ARLS(Index,b),tᵢ,tⱼ)=1+b(exp(r(Index,tᵢ,tⱼ))−1) (EQ. 4)

as positive one plus the product of leverage b and the difference of the index growth factor and one. Note that if the leverage multiple in EQ. 4 equals +1, then the growth factor of an ARLS is equal to that of an LRLS regardless of rebalancing period and index return. In other words, an IIP with leverage equal to +1 is at the same time both an LRLS and an ARLS. Mathematically speaking, a leverage multiple equal to +1 specifies a subspace in which the growth factors of ARLSs and LRLSs intersect over all time intervals and all index return values. Note that a leverage multiple equal to −1 is not included in this subspace.

The time-invariance property investors associated with ETFs (which are ARLSs) was actually a property of LRLSs. This time-invariance property disappeared with the debut of LETFs. The custom of mistakenly employing practical rules of thumb to fix problems however, lives on in the form of Lifetime LETFs. The earlier criticisms of these products will not be repeated here, but there is a parallel to be drawn. The incorrect time-invariance assumption regarding LETFs was based on a special case, the subspace of leverage equal to +1. The proposition of a Lifetime LETF is actually based on a trivial case, the single value of zero return. Although an ARLS is indistinguishable from an LRLS when return is zero, it is to no meaningful effect.

The LIIPs heretofore known suffer from a number of disadvantages.

(a) Daily LETFs exhibit significant value decay in flat markets and can underperform ETFs even when investors choose the directionally correct exposures.

(b) Monthly LETFs require larger rebalancing actions, which can overwhelm smaller markets and incentivize market participants to trade in front of the funds.

(c) Monthly LETFs exhibit uncontrolled leverage drift and risk total loss of investor assets.

(d) The longer-term return statistics of Monthly LETFs are substantially the same as those of Daily LETFs so the disadvantages of Monthly LETFs are not offset by any genuine advantages.

(e) Lifetime LETFs exhibit uncontrolled leverage drift and risk total loss of investor assets and do so without the safety net of monthly rebalancing.

(f) The shares in Lifetime LETFs are not fungible; therefore, intraday trading in the open market is not possible.

### SUMMARY OF THE INVENTION

In accordance with one embodiment, a computer-implemented method for structuring and maintaining an LIIP comprises determining a leverage regulator, monitoring the value of an index, monitoring the value of an investment with exposure to the index, calculating a leverage ratio of the investment to the index, calculating a leverage ratio adjustment in accordance with the leverage regulator, and calculating a rebalancing action to adjust the leverage ratio of the investment to a target leverage ratio.

Several advantages of one or more aspects are as follows: to provide LIIPs that offer investors improved return statistics, that show improved performance according to investor preferences, that have zero risk of total loss of investor assets, and that exhibit leverage drift in a predetermined manner. Other advantages of one or more aspects will be apparent from a consideration of the drawings and ensuing description.

### DRAWINGS

FIG. 1 illustrates graphs of leverage adjustment functions against leverage deviation effected for portfolio management of Daily LETFs and Lifetime LETFs.

FIG. 2 illustrates the graph of a leverage adjustment function against leverage deviation effected for portfolio management in accordance with one embodiment.

FIG. 3 illustrates a portion of the graphs of the cumulative distribution functions of several leveraged systems against annual logarithmic return values less than or equal to −60%.

FIG. 4 illustrates a portion of the graphs of the cumulative distribution functions of several leveraged systems against annual logarithmic return values between −60% and +60% inclusive.

FIG. 5 illustrates a portion of the graphs of the cumulative distribution functions of several leveraged systems against annual logarithmic return values greater than or equal to +60%.

FIG. 6 illustrates the graphs of the cumulative distribution functions of a Daily LETF and a Monthly LETF against annual logarithmic return values between −180% and +180% inclusive.

FIG. 7 illustrates the graph of a leverage adjustment function against leverage deviation effected for portfolio management in accordance with one embodiment.

The following tabulation lists reference numbers appearing in the drawings.

| | |
|---|---|
| 110 Daily LETF Regulator | 120 Lifetime LETF Regulator |
| 130 Diametric Cone | 210 Hysteresis Regulator |
| 310 LRLS CDF | 320 Daily LETF CDF |
| 330 Lifetime LETF CDF | 340 Hysteresis MLIIP CDF |
| 610 Monthly LETF CDF | 710 Numerical Regulator |

### GLOSSARY

Due to the technical nature of material discussed herein, working definitions for some specialized language are provided in this section.

Arithmetic Return: percent change in value from one time to another; the arithmetic return a(•) of asset XYZ from time index i to time index j equals

$$a ( XYZ , {t}_{i} , {t}_{j} ) = \frac{v ( XYZ , {t}_{j} )}{v ( XYZ , {t}_{i} )} - 1$$

the ratio of values minus one, where the difference j−i in time indices is a positive number.

Arithmetic Return Leveraged System (ARLS): a system characterized by a constraint specifying the arithmetic return of the system over a specified time interval be equal to

a(ARLS(Index,b),tᵢ,tⱼ)=ba(Index,tᵢ,tⱼ)

the product of leverage b and arithmetic return of the index, where the difference j−i in time indices is a positive number and tⱼ−tᵢ represents the rebalancing period; see Arithmetic Return (Paragraph 52).

Growth Factor: normalized value; the growth factor y(•) of asset XYZ from time index i to time index j equals

$$y ( XYZ , {t}_{i} , {t}_{j} ) = \frac{v ( XYZ , {t}_{j} )}{v ( XYZ , {t}_{i} )}$$

the ratio of values at different times, where the difference j−i in time indices is a positive number.

Hadamard Product: an element-by-element matrix product. In an n-dimensional finite space, the Hadamard product of vectors [x] and [z] equals

[x]∘[z]=[x₁z₁x₂z₂ . . . xₙ₋₁zₙ₋₁xₙzₙ]

a vector of dimension n comprised of elements equaling the products of the corresponding elements of the individual vectors.

Leveraged Indexed Investment Product (LIIP): an investment product offering indexed returns employing a leverage multiple other than +1. The leverage multiples −3, −2, −1, +2, and +3 serve as nonlimiting examples.

Logarithmic Return (also Log Return): growth in value from one time to another; the log return r(•) of asset XYZ from time index i to time index j equals

r(XYZ,tᵢ,tⱼ)=ln(y(XYZ,tᵢ,tⱼ))

the natural logarithm (logarithm base e) of the relevant growth factor, where the difference in time indices j−i is a positive number.

Logarithmic Return Leveraged System (LRLS): a system characterized by a constraint specifying the log return of the system over a specified time interval be equal to

r(LRLS(Index,b),tᵢ,tⱼ)=br(Index,tᵢ,tⱼ)

the product of leverage b and log return of the index, where the difference j−i in time indices is a positive number and tⱼ−tᵢ represents the rebalancing period; see Logarithmic Return (Paragraph 57).

Lₚ Norm (herein used interchangeably with vector norm): a measure of size satisfying the geometric properties of homogeneity, subadditivity, and nonnegativity. In an n-dimensional finite space, the Lₚ norm of vector [x] equals

∥[x]∥ₚ=(|x₁|^{p}+ . . . +|xₙ|^{p})^{1/p}

the p root of the sum of the absolute values of the elements of vector [x] each exponentiated by p, where p is one of greater than positive one and equal to positive one. The infinite space analog is the p root of the definite integral of the absolute value of a function x(•) exponentiated by p.

### DETAILED DESCRIPTION

Assets are modeled as systems which change at a rate that is a multiple of contemporaneous value. Consider the following first-order ordinary differential equation,

dv=cvdt (EQ. 5)

in which differential change in value dv equals the product of growth rate c and value v over differential change in time dt. Correctly solving EQ. 5 yields

$$\frac{v ( {t}_{j} )}{v ( {t}_{i} )} = exp ( c ( {t}_{j} - {t}_{i} ) ) \qquad ( EQ . 6 )$$

a growth factor from tᵢ to tⱼ equal to the exponential function of the product of growth rate c and elapsed time. The argument of the exponential function in EQ. 6 equals logarithmic return r(•) over elapsed time.

The evolution of a Daily LETF and a Lifetime LETF over two rebalancing periods is analyzed as a nonlimiting example with notation simplified to the extent possible. The rebalancing period is assumed to be one day. Let r₁ and r₂ be the consecutive daily log returns of an index. The two-day growth factor of the Daily LETF is written

y(Daily LETF(b))=(1+b(exp(r₁)−1))(1+b(exp(r₂)−1)) (EQ. 7)

by applying EQ. 4 successively. Employ the power series definition of the exponential function

exp(x)=1+x+½x²+⅙x³+ . . . (EQ. 8)

to represent the two-day growth factor in terms of log return. Substitution of EQ. 8 into EQ. 7 yields

$$\begin{matrix}y ( Daily LETF ( b ) ) \approx 1 + b ( {r}_{1} + {r}_{2} ) + \frac{1}{2} {{b}^{2} ( {r}_{1} + {r}_{2} )}^{2} + \\ \frac{1}{2} ( b - {b}^{2} ) ( {r}_{1}^{2} + {r}_{2}^{2} ) \\ \approx exp ( b ( {r}_{1} + {r}_{2} ) + \frac{1}{2} ( b - {b}^{2} ) ( {r}_{1}^{2} + {r}_{2}^{2} ) ) \\ \approx y ( LRLS ( b ) ) exp ( \frac{1}{2} ( b - {b}^{2} ) ( {r}_{1}^{2} + {r}_{2}^{2} ) )\end{matrix} \qquad ( EQ . 9 )$$

the relationship between the Daily LETF and an LRLS. Since return terms exponentiated by values greater than positive two are functions of time exponentiated by values greater than positive one, they are excluded with negligible effect. Although the complete derivation is not shown step-by-step, a person having ordinary skill in Portfolio Management has the capability of completing it.

For the LIIPs under consideration in the present disclosure (those with leverage multiples equal to one of less than −1, equal to −1, and greater than +1) the leverage difference term b−b² in EQ. 9 is always negative. Excluding the trivial case of zero return on both of days one and two, the multiplicand of the LRLS growth factor in EQ. 9 is uniquely less than positive one. Value decay relative to the LRLS is a function of the sum of the squares of daily index returns. A Daily LETF experiences value decay relative to an LRLS regardless of the specific values of the daily returns of the index. Without the continuous rebalancing assumption, EQ. 9 differs from EQ. 1 but does not contradict the research summarized in Paragraph 20. Similar two-step examples in prior art illustrate value decay only when index log returns sum to zero: lacking a universal leveraged model without value decay, zero return was employed by others as an easily perceivable benchmark.

The two-day growth factor of a Lifetime LETF is considered under the same index returns. Without rebalancing, the leverage multiple of a Lifetime LETF over the second day will be different than over the first day. Assuming leverage b over day one, the leverage multiple over day two

$$Lifetime LETF Day 2 Leverage = \frac{b exp ( {r}_{1} )}{1 + b ( exp ( {4}_{1} ) - 1 )} \qquad ( EQ . 10 )$$

is a function of initial leverage and day-one index return. EQ. 10 and EQ. 8 together with a variable-leverage adaptation of EQ. 7 yield

$$\begin{matrix}y ( Lifetime LETF ( b ) ) \approx 1 + b ( {r}_{1} + {r}_{2} ) + \frac{1}{2} {{b}^{2} ( {r}_{1} + {r}_{2} )}^{2} + \\ \frac{1}{2} ( b - {b}^{2} ) {( {r}_{1} + {r}_{2} )}^{2} \\ \approx exp ( b ( {r}_{1} + {r}_{2} ) + \frac{1}{2} ( b - {b}^{2} ) {( {r}_{1} + {r}_{2} )}^{2} ) \\ \approx y ( LRLS ( b ) ) exp ( \frac{1}{2} ( b - {b}^{2} ) {( {r}_{1} + {r}_{2} )}^{2} )\end{matrix} \qquad ( EQ . 11 )$$

the relationship between the Lifetime LETF and an LRLS. As was the case with the preceding Daily LETF example, return terms exponentiated by values greater than positive two are excluded with negligible effect as they are functions of time exponentiated by values greater than positive one. Again, a person having ordinary skill in Portfolio Management can complete the derivation. Value decay is a function of the square of the sum of daily index returns. A Lifetime LETF experiences value decay relative to the LRLS if the returns of the index have a nonzero sum. A Lifetime LETF does not experience value decay if the returns of the index have a zero sum even if the daily returns are nonzero.

Compared to EQ. 9, EQ. 11 contains an additional cross term (2r₁r₂). Keeping in mind the leverage difference term b−b² in both EQ. 9 and EQ. 11 is always negative, this cross term serves to reduce value decay when the daily index returns are of opposite sign. To generalize, this circumstance is consistent with sideways markets characterized by many direction reversals. In such markets, Lifetime LETFs perform better than Daily LETFs. The cross term in EQ. 11 serves to increase value decay when the daily index returns have the same sign. This circumstance is consistent with strongly trending markets characterized by few direction reversals. In such markets, Daily LETFs perform better than Lifetime LETFs.

Extension of this comparison between Daily LETFs and Lifetime LETFs allows for a characterization of market regimes. The performance benefit of Daily LETFs over Lifetime LETFs is maximized when the ratio of the magnitude of index mean average return to volatility is maximized. The value of this ratio is maximized (reaching infinite value) when volatility (and hence variance) is zero. The performance benefit of Lifetime LETFs over Daily LETFs is maximized when the same ratio is minimized. The value of this ratio is minimized (reaching zero value) when index mean average return is zero. In the trivial case of both daily index returns being equal to zero, the ratio is indefinite and the performance of the two types of LETFs is equivalent. The investment returns of Daily LETFs and Lifetime LETFs are optimized in diametrically opposed statistical regimes.

A weakly trending market exposes a characteristic of Daily LETFs that many investors have found categorically disturbing. It is not uncommon for an index to have been up slightly over some time interval during which +2× and +3× Daily LETFs not only did not provide that multiple of index return but have actually decreased in value. In other words, investors lost money even after picking the directionally correct exposure.

There are multiple ways to identify or specify an LIIP. Daily LETFs and Monthly LETFs are typically specified by a leverage multiple and rebalancing period. This is a logical framework since the target leverage multiple is a constant value. This same framework is not constructive for Lifetime LETFs because target leverage varies according to the price evolution of its index, meaning target leverage is a function of the lifetime return of the index. Substantive analysis of LIIPs requires a universally applicable, mathematically tractable framework.

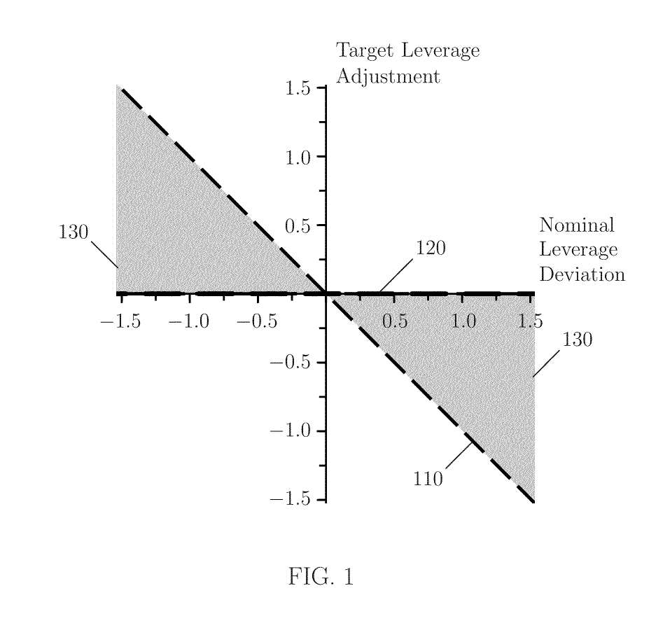

In FIG. 1, a framework for substantive analysis of LIIPs is shown, that of the two-dimensional space of Target Leverage Adjustment versus Nominal Leverage Deviation. The horizontal axis represents the difference between the leverage value of a fund and its Nominal Leverage. Nominal Leverage should be understood to mean the value in the stated return objective with the stipulation that leverage may be permitted to deviate from this value. The vertical axis represents the target value for adjusting leverage as specified by the fund's portfolio management protocol. A graph in this two-dimensional space, along with leverage initial condition and rebalancing period parameter, serves to uniquely specify an LIIP.

In FIG. 1, both Daily LETFs and Lifetime LETFs may be specified in a convenient manner. The portfolio management protocol of a Daily LETF requires adjusting leverage by a magnitude equal to and in the direction opposite of the Nominal Leverage Deviation effected by the market return of the underlying index (see descriptive example in Paragraph 16). In the two-dimensional leverage space defined, a Daily LETF is represented by the graph of Daily LETF Regulator 110, shown as a line with negative unit slope crossing the origin. Since a Lifetime LETF never rebalances, it is illustrated by the graph of Lifetime LETF Regulator 120, shown as a horizontal line superimposed on the horizontal axis. Values for Target Leverage Adjustment between those of a Daily LETF and a Lifetime LETF form Diametric Cone 130.

The Target Leverage Adjustment required by the portfolio management protocol of an LIIP is provided by evaluating a Leverage Regulator, which is a function of Nominal Leverage Deviation. The graph of Daily LETF Regulator 110 in FIG. 1 is

g(Daily LETF)=−q (EQ. 12)

the negative of Nominal Leverage Deviation q. Although EQ. 12 applies to any LIIP with constant-value target leverage, the only one under consideration is a Daily LETF. The graph of Lifetime LETF Regulator 120 in FIG. 1 is

g(Lifetime LETF)=0 (EQ. 13)

the constant value zero. Because the Leverage Regulator specifies (indirectly) the target value of leverage going forward it is said to govern the LIIP.

The horizontal axis of the leverage space shown in FIG. 1 may extend to only the negative value of Nominal Leverage. For +3× LETFs, Nominal Leverage Deviation may be no less than −3. For −3× LETFs, Nominal Leverage Deviation may be no greater than +3. This limit on one side of the horizontal axis does not affect the present disclosure.

A Multifactorial Leveraged Indexed Investment Product (MLIIP) is an LIIP offering returns with statistical characteristics representing advantageous aspects of an LRLS. The Leverage Regulator governing an MLIIP is the MLIIP Regulator.

### First Embodiment

In accordance with one embodiment, the method of the present disclosure includes determining, with a computer, a Leverage Regulator governing an LIIP tracking an underlying index. This comprises execution of what is typically referred to as a Monte Carlo simulation, the details of which are covered herein.

Generate a Sample Index (SI) comprised of Sample Index Trajectories. The SI serves as a training set. Determine a mean average value and a volatility value that is consistent with the daily logarithmic returns of the underlying index. Sample m=252 random numbers taken from a normal distribution parametrized by the mean average and volatility values determined to be consistent with the underlying index. This set of values specifies a single one-year trajectory of the Sample Index. Generate n=1000 of these one-year Sample Index Trajectories. In this embodiment, the normal distribution serves as the selected Sample Index Statistical Distribution. In this embodiment, the choice of 252 daily returns indicates the selected Time Interval is one year.

Arrange the SI Trajectories as column vectors to populate SI Daily Return Matrix [R(SI)] with m rows and n columns. The daily log returns of trajectory k of the Sample Index are represented in vector form as column k

[R(SI)]_{[·,k]}=[r(SI(k),t₀,t₁) . . . r(SI(k),tₘ₋₁,tₘ)]^{T} (EQ. 14)

of SI Daily Return Matrix [R(SI)]. The first element on the right-hand side of EQ. 14 is the first daily log return of trajectory SI(k).

Arrange the sum of each column in SI Daily Return Matrix [R(SI)] into SI Cumulative Return Vector [r(SI)] with n rows

[r(SI)]=[r(SI(1),t₀,tₘ) . . . r(SI(n),t₀,tₘ)]^{T} (EQ. 15)

in which element k of SI Cumulative Return Vector [r(SI)] in EQ. 15 is the cumulative log return of SI(k) over m days.

Scaling the elements of SI Cumulative Return Vector [r(SI)] by Nominal Leverage will yield the cumulative log returns of an LRLS tracking each SI Trajectory. These returns will be used to measure the Pairwise Return Differences between the theoretically ideal LRLS and a Candidate Leveraged Indexed Investment Product (CLIIP). The return differences are understood to be pairwise because each difference compares the value evolution of the LRLS and CLIIP when tracking the same SI Trajectory.

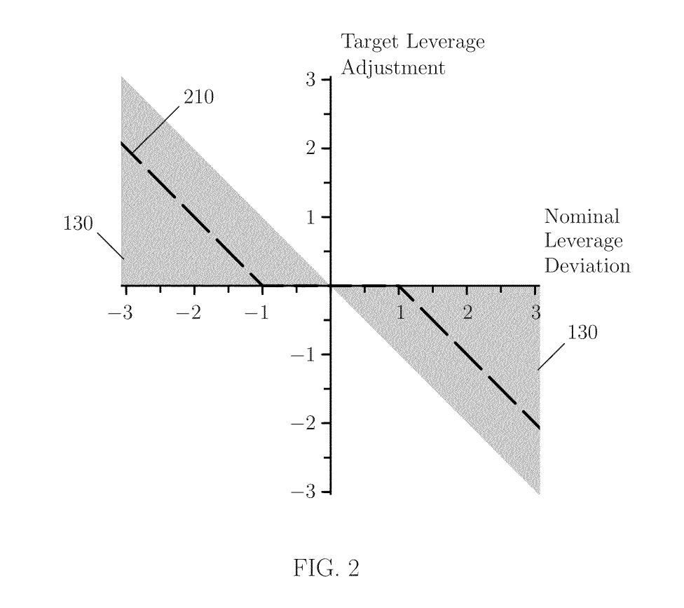

Calculate the cumulative log returns of the CLIIP tracking each SI Trajectory. The CLIIP is governed by a Candidate Leverage Regulator. In FIG. 2 is shown the graph of Hysteresis Regulator 210, an exemplary Candidate Leverage Regulator. The graph is typically referred to as a dead-zone function,

$$g ( CLII P ) = \{ \begin{matrix}0 & if \vert q \vert < {h}_{1} \\ - sgn ( q ) ( \vert q \vert - {h}_{1} ) & otherwise\end{matrix} \qquad ( EQ . 16 )$$

where h₁ is an optimization parameter constrained to be positive and sgn(•) is the sign function. The parameter represents the magnitude of the dead-zone region. In this embodiment, the Candidate Leverage Regulator is specified by the dead-zone function. In this embodiment, Parameter Vector [h] is specified by element h₁ and has dimension one.

Calculating the cumulative log returns of the CLIIP involves simulating its value evolution across multiple rebalancing periods. The need for rebalancing to maintain leverage was introduced earlier (see Paragraph 16). Simulation of the portfolio management process is trivial in the case of a Daily LETF because leverage is modeled as a known constant for each day. In the general case, leverage is not a constant but a variable, the value of which may be different across each rebalancing period.

Normalize to positive one the initial value of CLIIP Trajectory k, v(CLIIP(k),t₀)=1, which tracks SI(k). Set the initial value of leverage, b(CLIIP(k),t₀)=b₀, to Nominal Leverage. Given the first daily log return r(SI(k),t₀,t₁) of SI(k), calculate the growth factor of the CLIIP

y(CLIIP(k),t₀,t₁)=1+b(CLIIP(k),t₀)(exp(r(SI(k),t₀,t₁))−1) (EQ. 17)

across day one, which is used to calculate v(CLIIP(k),t₁).

Assume rebalancing is done at the end of the trading day and that the value of the index at the end of the rebalancing process is substantially the same as its value at the beginning of the rebalancing process. This assumption should be understood to mean that, for the purpose of simulating the CLIIP, it is only fund leverage that changes during the rebalancing process.

Calculate the leverage value of the CLIIP just before the beginning of the rebalancing process on day one,

$$b ( CLII P ( k ) , {t}_{1}^{-} ) = \frac{b ( CLII P ( k ) , {t}_{0} ) exp ( r ( SI ( k ) , {t}_{0} , {t}_{1}^{-} ) )}{1 + b ( CL II P ( k ) , {t}_{0} ) ( exp ( r ( SI ( k ) , {t}_{0} , {t}_{1}^{-} ) ) - 1 )} \qquad ( EQ . 18 )$$

which is a straightforward implementation of EQ. 10. It should be understood that index values at t₁⁻ and t₁ are considered equivalent. As a side note, application of EQ. 18 to the example in Paragraph 16 yields a leverage value of +2.94 (=(3×1.01)/(1+3(1.01−1))). Calculate the Nominal Leverage Deviation of the CLIIP

q(CLIIP(k),t₁⁻)=b(CLIIP(k),t₁⁻)−b₀ (EQ. 19)

just before the beginning of the rebalancing process. Note that Nominal Leverage b₀ in EQ. 19 always serves as the reference for measuring Nominal Leverage Deviation; it is never updated.

Evaluation of Candidate Leverage Regulator g(CLIIP) from EQ. 16, indicating the Target Leverage Adjustment to be effected by the portfolio manager, serves to specify the leverage value to be used

b(CLIIP(k),t₁)=b(CLIIP(k),t₁⁻)+g(q(CLIIP(k),t₁⁻)) (EQ. 20)

over day two of the simulation of CLIIP(k). Repeat these steps for every daily log return value of SI(k) to calculate the final value, v(CLIIP(k),tₘ), of trajectory CLIIP(k) tracking SI(k). Since the initial value was normalized to positive one, the cumulative log return of CLIIP(k) is

r(CLIIP(k),t₀,tₘ)=ln(v(CLIIP(k),tₘ)) (EQ. 21)

the natural logarithm of its final value.

Repeat the series of steps described in the paragraphs from Paragraph 80 through Paragraph 83 inclusive to generate n number of CLIIP Trajectories. Using EQ. 21, calculate the cumulative log return of each. Arrange the cumulative log returns in CLIIP Cumulative Return Vector [r(CLIIP)]

[r(CLIIP)]=[r(CLIIP(1),t₀,tₘ) . . . r(CLIIP(n),t₀,tₘ)]^{T} (EQ.22)

with n rows. The returns in both EQ. 15 and EQ. 22 will be used to measure the Pairwise Return Differences between the LRLS and the CLIIP.

A Weighting Vector [w(SI)] is specified as a function of the Sample Index. If the cumulative log return of SI(k), element k in SI Cumulative Return Vector [r(SI)], is in the center 10% of all values of [r(SI)], then set element k in Weighting Vector [w(SI)] to +11. If element k of [r(SI)] is outside of the center 10% of values, set element k in [w(SI)] to +1. Because the daily log returns of the Sample Index were chosen from a normal distribution, the cumulative log returns of the trajectories make up a set consistent with a normal distribution. There is a 90% probability associated with a weight of +1 and a 10% probability with a weight of +11.

The value of +1 across the entire range of [w(SI)] values gives a total weighting of +1000 to Mean Average Return of the Sample Index. The increase in weighting by +10 for the center 10% of values gives a total weighting of +1000 to Mode Return of the Sample Index. This is the case because the mode value of a normal distribution is equal to the median value of a normal distribution. In this embodiment, the weightings of +1000 and +1000 serve as the selected Positive Weightings.

The MLIIP Regulator satisfies the performance criteria of

$${min}_{[ h ]} {‖ [ w ( SI ) ] ∘ [ [ r ( CL Π P ) ] - {b}_{0} [ r ( SI ) ] ] ‖}_{2} \qquad ( EQ . 23 )$$

minimizing, over Parameter Vector [h], the weighted L₂ norm (see definition, Paragraph 59) of the log return differences between the CLIIP and the LRLS effecting Nominal Leverage b₀. Each of the vectors [w(SI)], [r(CLIIP)], and [r(SI)] in EQ. 23 has n rows and one column. The weighting vector acts on the vector of return differences by the Hadamard product (see definition, Paragraph 55). The argument of the weighted L₂ norm has n rows and one column, and the norm itself is a scalar value. In this embodiment, the L₂ norm serves as the selected Mathematical Norm Function.

Several parameter values related to execution of the Monte Carlo simulation were selected as part of this embodiment. The time discretization for simulation of the Sample Index Trajectories and CLIIP was selected to be daily. That daily rebalancing is a proxy for continuous rebalancing, allowing for accurate simulation, has been established in prior art. Any discretization allowing for accurate simulation is acceptable. The selected number of Sample Index Trajectories is 1000. There is no analytical solution for determining a minimum necessary number of trials for a Monte Carlo simulation; the number is often in the range between 1000 and 100,000 in Finance. As Monte Carlo simulations are studied in Finance, a person having ordinary skill in Portfolio Management has the capability of choosing the relevant parameters and conducting the simulation.

The frequency for rebalancing the CLIIP was selected to be once per day. The schedule for rebalancing the CLIIP was selected to be near the end of the day. Any frequency and schedule supporting accurate portfolio management is acceptable. A person having ordinary skill in Portfolio Management has the capability of specifying such a frequency and schedule.

The selected Sample Index Statistical Distribution is normal, also known as a Gaussian distribution. There is debate as to whether or not markets exhibit price dynamics consistent with a normal distribution. Many non-normal distributions satisfy the conditions of the Central Limit Theorem (CLT), meaning they tend towards normal over time. As statistical distributions are studied in Finance, a person having ordinary skill in Portfolio Management is capable of choosing a distribution representative of the underlying index.

The selected Time Interval is one year. It is the investment horizon of interest. The selected period should reflect market demand—that is to say, investor preferences—as determined by the fund sponsor. Likewise, the choice of the underlying index and the value of Nominal Leverage should reflect market demand for leveraged products as determined by the fund sponsor.

The Candidate Leverage Regulator is specified to effect hysteresis. Hysteresis is a term describing behavior that is dynamic in nature as opposed to instantaneous. A dynamic system evolves over time, which is equivalent to evolving with a time lag. There is no unique form for specifying hysteresis. Any Leverage Regulator represented by a graph existing within (but not exclusively on the boundary of) Diametric Cone 130 effects hysteresis. I believe that a Leverage Regulator specified by a dead-zone function is preferable in this embodiment because of the straightforward manner in which it can be implemented and audited, but other Leverage Regulators are also satisfactory. All Leverage Regulators effecting hysteresis and satisfying investor preferences in relation to utility functions as determined by the fund sponsor are also satisfactory.

Hysteresis is observed in the physical sciences and is used in various engineering disciplines. The change in temperature of a mass lags the energy flow driving it. The voltage across a capacitor lags the electrical current driving it. In the field of circuit design, hysteresis may be used to ameliorate the undesirable characteristic of rapid reversals near a threshold value. A climate control system set to a temperature of 23 degrees Celsius may begin cooling only after the temperature has increased to 24 degrees Celsius and may continue cooling until the temperature has decreased to 22 degrees Celsius. This has the effect of increasing the period of inactivity between cooling cycles, which in turn increases the service life of equipment. An automobile suspension imposes a lag in any change of the vertical position of the passenger compartment relative to the road surface, allowing for increased passenger comfort. The use of any hysteresis variant in determining the MLIIP Regulator does not qualify as encompassing substantially all uses of a physical phenomenon.

The selected Mathematical Norm Function is the L₂ norm. A norm in mathematics is any function, or mathematical relationship, used for measuring size and which satisfies certain properties. An L₂ norm of deviations of data values from a mean average calculates a quantity known as standard deviation (or volatility) in statistics. I believe that an L₂ norm is preferable in this embodiment because of its connection to volatility, but other norms are also satisfactory. Other Lₚ norms satisfying investor preferences in relation to utility functions as determined by the fund sponsor are also satisfactory. Any norm satisfying investor preferences in relation to utility functions as determined by the fund sponsor is satisfactory.

Norms are used in the physical sciences and engineering disciplines. An L_{∞} (L-infinity) norm calculates maximum magnitude, which may be used to establish the specification of an electrical circuit subject to power spikes. An L₁ norm calculates the sum of absolute values, which may be used to represent cost in the presence of limited resources. The Pythagorean Theorem is a two-dimensional reduction of the L₂ norm. A root-mean-square norm calculates a time-averaged L₂ norm of power in a circuit. The use of any norm variant in determining the MLIIP Regulator does not qualify as covering all substantial practical uses of a mathematical relationship.

The selected Positive Weightings are +1000 for Mean Average Return and +1000 for Mode Return. It is the relative values that are relevant, and in this embodiment, they indicate the two statistical parameters are weighted equally. The relative values should satisfy investor preferences in relation to utility functions as determined by the fund sponsor.

The disclosed method for determining the MLIIP Regulator serves to structure the MLIIP. Optimization software may provide a means of evaluating the performance metric specified by the user and modifying the optimization parameter or parameters subject to applicable numerical analysis theory so as to optimize the performance metric. Modification of the optimization parameter or parameters is subject to constraints specified by the user. In this embodiment,

(a) the performance metric is the weighted L₂ norm;

(b) the optimization parameter is h₁ from EQ. 16; and

(c) the optimization parameter constraint is that h₁ be positive.

Details regarding specific optimization products are not provided. Operation of such software may include but is not limited to specifying initial optimization parameter values, optimization parameter increments, and performance metric convergence criteria. As Portfolio Optimization is a field of study in Finance, a person having ordinary skill in Portfolio Management has the capability of operating such software.

The content found in the paragraphs from Paragraph 73 through Paragraph 97 inclusive provides disclosure of the method for determining the MLIIP Regulator in accordance with one embodiment that is sufficient for a person having ordinary skill in Portfolio Management.

In accordance with one embodiment, the method of the present disclosure includes monitoring, with a computer, the MLIIP. Access, with a computer, market values and asset exposures of the MLIIP. Calculate, with a computer, the leverage of the MLIIP. The leverage of the MLIIP less Nominal Leverage provides Nominal Leverage Deviation. Evaluate, with a computer, the MLIIP Regulator to provide Target Leverage Adjustment given the Nominal Leverage Deviation. By computer, output the Target Leverage Adjustment to a display at a scheduled time each trading day.

The schedule for monitoring is selected to be daily. Any schedule supporting accurate portfolio management is acceptable. A person having ordinary skill in Portfolio Management has the capability of specifying such a schedule.

In accordance with one embodiment, the method of the present disclosure includes rebalancing, with a computer, the portfolio of the MLIIP. Access, with a computer, the Target Leverage Adjustment provided by the MLIIP Regulator. Calculate, with a computer, the number of units of the underlying index to be traded to effect the Target Leverage Adjustment. By computer, output to a display the trade order, including the number of units and whether they are to be bought or sold. A portfolio manager executes the trade order at a scheduled time each trading day. In this embodiment, the underlying index serves as the selected Transaction Index.

The schedule for rebalancing is selected to be daily. Any schedule supporting accurate portfolio management is acceptable. A person having ordinary skill in Portfolio Management has the capability of specifying such a schedule.

The selected Transaction Index is the underlying index. Any assets providing returns substantially the same as those of the underlying index of the MLIIP may be selected as a Transaction Index. A person having ordinary skill in Portfolio Management has the capability of selecting a Transaction Index.

The content found in the paragraphs from Paragraph 99 through Paragraph 103 inclusive provides disclosure of the method for maintaining the MLIIP in accordance with one embodiment that is sufficient for a person having ordinary skill in Portfolio Management.

### Operation

Consider an index with a log-normal price distribution having zero mean average and 20% annual volatility, which means the log returns of the index have a normal distribution with the same mean average and volatility. Execution of the disclosed method for determining the leverage regulator of a +3× LIIP in accordance with the first embodiment produced the results in the following tabulation.

| Parameter h₁ | 0 | 0.5 | 1.0 | 1.5 | 2 | 2.5 |
|---|---|---|---|---|---|---|
| Weighted L₂ Norm | 13.49 | 12.14 | 9.87 | 9.83 | 9.89 | 10.02 |

The tabulation above shows weighted L₂ norms of the candidate Hysteresis Regulator for the parameter values shown. Although not shown, a parameter value of 1.25 yielded the minimum norm value of 9.80. The results for this embodiment suggest that parameter values between 1.0 and 2.0 inclusive offer substantially the same performance. I believe that a parameter value of 1.0 is preferable in this embodiment because it limits leverage drift more than the other values, but the other values ranging from 1.0 to 2.0 are also satisfactory. The candidate Hysteresis Regulator with parameter value of 1.0 is referenced by the term Hysteresis Regulator hereinafter. The CLIIP governed by the Hysteresis Regulator is referenced by the term Hysteresis MLIIP hereinafter.

The same performance metric is used for comparison with prior art LIIPs, the results of which are shown in the tabulation below.

| Hysteresis MLIIP | Daily LETF | Monthly LETF | Lifetime LETF |
|---|---|---|---|
| 9.87 | 13.49 | 14.53 | Infinite |

The weighted norm for the Daily LETF is 13.49, its portfolio management protocol being equivalent to a reduction of the candidate Hysteresis Regulator with parameter set to zero. The weighted norm for the Monthly LETF equals 14.53 and is included for completeness. The weighted norm for the Lifetime LETF is infinite. If a Lifetime LETF tracking an SI Trajectory loses all value, the cumulative log return associated with that trajectory is negative infinity. This catastrophic loss controls the weighted Lₚ norm over all trajectories regardless of the value of p and causes the performance metric to have infinite value. This 100% loss of value occurred in 34 of 1000 trajectories. Of the SI Trajectories, zero caused the Monthly LETF to lose all value.

The sponsors of Lifetime LETFs state that their funds would be rebalanced to avoid a complete loss of investor assets. On the condition the +3× Lifetime LETF is rebalanced to +3× upon reaching 10% of its original value, at which point leverage would equal +21, its weighted norm is 13.45. This 90% loss occurred in 75 of 1000 trajectories. If this rebalancing threshold is increased dramatically from 10% to 50%, the weighted norm becomes 12.78. Even with the benefit of a rebalancing protocol specifically designed to address one of its weaknesses, a Lifetime LETF still performs only marginally better than a Daily LETF. The Lifetime LETF with rebalancing at 10% of its original value serves as an exemplary +3× Lifetime LETF hereinafter.

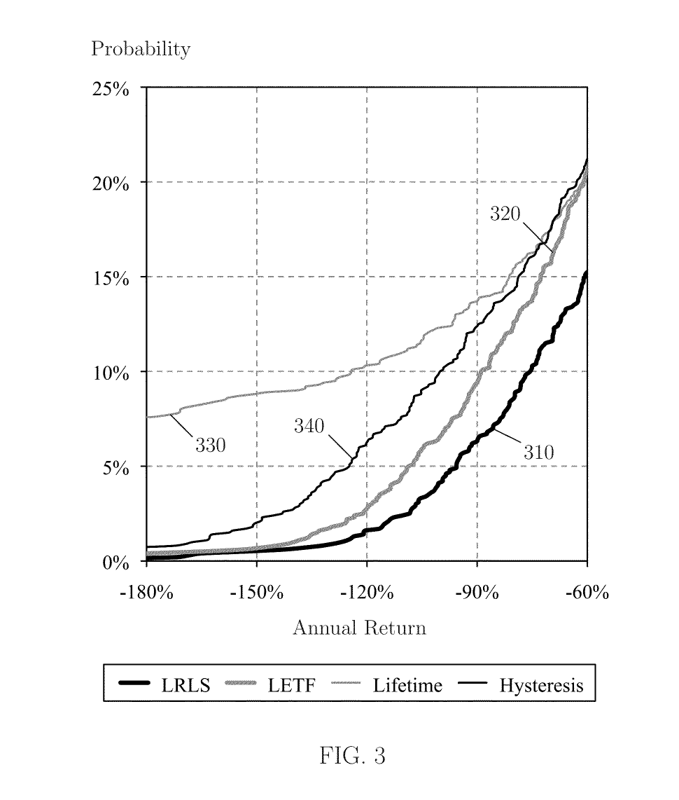

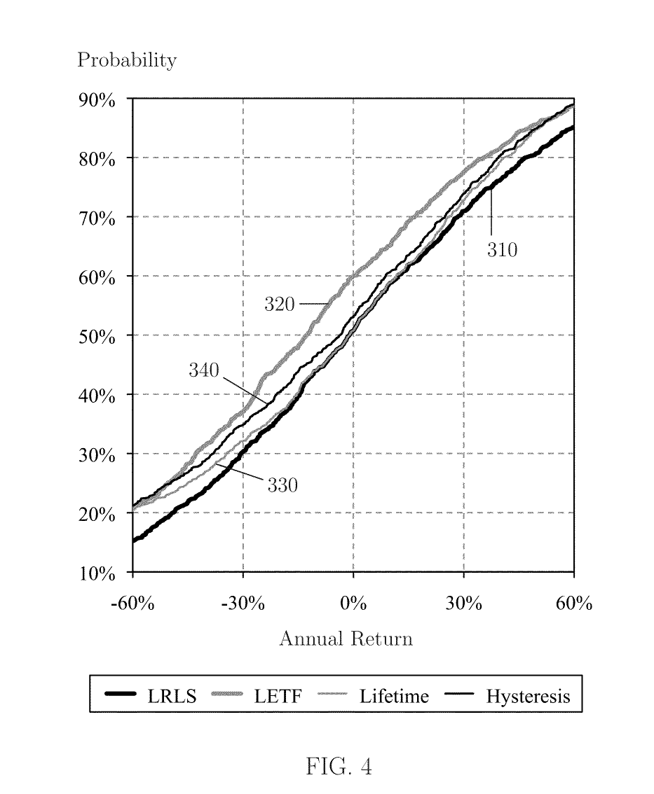

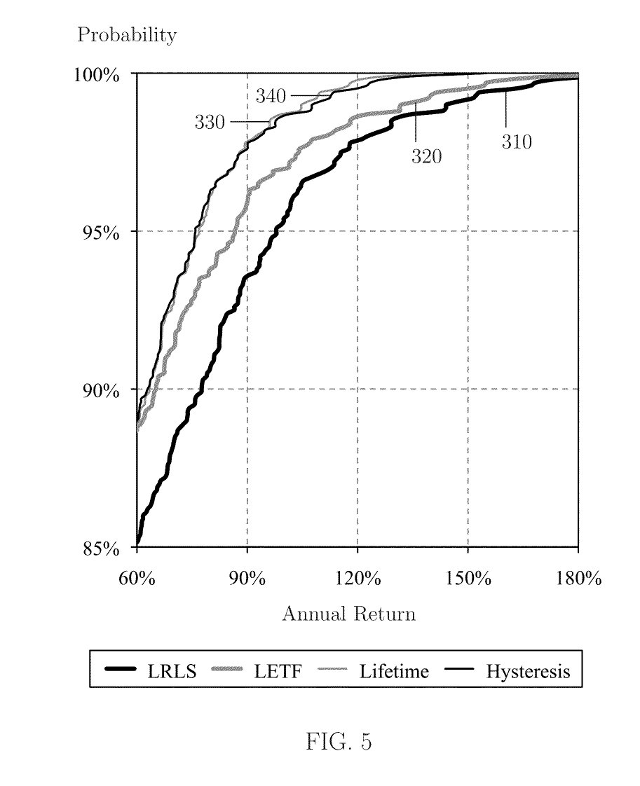

In FIG. 3, FIG. 4, and FIG. 5 are shown graphs of the cumulative distribution function (CDF) for each of the LRLS, Daily LETF, Lifetime LETF, and Hysteresis MLIIP against cumulative annual log return as these systems tracked the SI Trajectories. Because daily rebalancing remains the archetype of the sector, “LETF” is used in the legend of every figure to denote the Daily LETF. Each leveraged system has Nominal Leverage equal to +3. In terms of visual display, graphs shifted to the right are advantageous because there is a greater maximum return associated with a given probability. As the theoretical ideal, LRLS CDF 310 represents an upper limit on the performance of all LIIPs.

In FIG. 3, the values of the horizontal axis range from three to one standard deviations below the mean log return of the LRLS, including about 16% of trajectories. Because the price action of these SI Trajectories exhibits strong trending, Daily LETF CDF 320 shows better performance than the other LIIPs. Lifetime LETF CDF 330 is the worst with these trajectories for the same reason. Hysteresis MLIIP CDF 340 is between these two but significantly better than the Lifetime LETF. As the graphs head toward an annual return of −60%, the advantage of the Daily LETF over the other two LIIPs deteriorates.

In FIG. 4, the values of the horizontal axis range from one standard deviation below to one standard deviation above the mean log return of the LRLS, including about 68% of trajectories. Over the entire range, Daily LETF CDF 320 shows the worst statistics. Because the price action of these SI Trajectories exhibits weak trending, Lifetime LETF CDF 330 shows better performance than the other LIIPs. For the special case of zero return, the Lifetime LETF is equivalent to the LRLS. Hysteresis MLIIP CDF 340 is here next best to the Lifetime LETF and significantly better than the Daily LETF. The median value (corresponding to 50% probability) of the Hysteresis MLIIP is 2% less than the LRLS and Lifetime LETF. The median value of the Daily LETF is 10% less than the Hysteresis MLIIP.

In FIG. 5, the values of the horizontal axis range from one to three standard deviations above the mean log return of the LRLS, including about 16% of trajectories. The relative performance is approximately the mirror image of FIG. 3. Although these SI Trajectories exhibit strong trending, the performance improvement of the Hysteresis MLIIP over the Lifetime LETF is not as pronounced as in FIG. 3. The reason is that the dead-zone function of the Hysteresis Regulator in the first embodiment, allowing for leverage variation between +2 and +4, is not symmetric within a log return framework. Details surrounding this notion of symmetry are discussed in an additional embodiment, that of the Logarithmic Dead-Zone Regulator. As return values tend towards extremes, the graph of Daily LETF CDF 320 once again moves from those of the other LIIPs to that of LRLS CDF 310.

In light of this, the method of the present disclosure shows unexpected results related to its structure. Even though Hysteresis Regulator 210 is within Diametric Cone 130 bounded by Daily LETF Regulator 110 and Lifetime LETF Regulator 120, it provides a performance improvement over prior art LIIPs and portfolio combinations thereof. It is expected that optimization will find a range of parameter values for which a performance metric is at or near its optimum value. Optimizing the Parameter Vector was a step in determining the Hysteresis Regulator of the first embodiment, but the benefit derived from the optimization itself is limited by its formulation. The CDFs show the Hysteresis MLIIP to behave more like a Daily LETF in one statistical regime and more like a Lifetime LETF in another. This advantageous behavior, evidenced by the relative values of the weighted L₂ norms of the LIIPs, is a result not achievable with any fixed-allocation portfolio of prior art LIIPs and furthermore does not require any prediction of index behavior. The method of the present disclosure, providing a quantifiable performance improvement across different statistical regimes, is demonstrated to differ from prior art in kind.

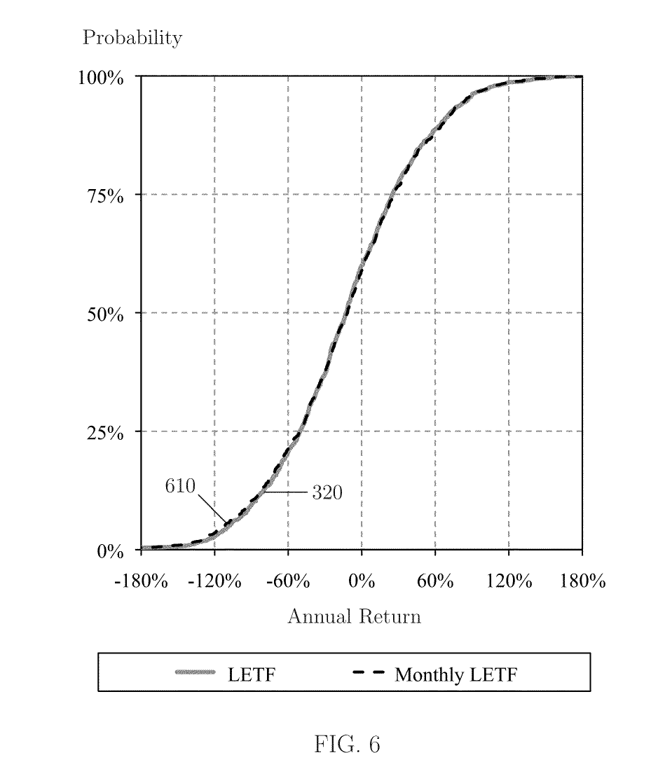

In FIG. 6 are shown the graphs of the CDF for each of the Daily LETF and Monthly LETF. Monthly LETF CDF 610 follows that of Daily LETF CDF 320 almost exactly. As mentioned in Paragraph 30, the longer-term return statistics of Monthly LETFs are substantially the same as those of Daily LETFs. Even though the Monthly LETF had been rebalanced many fewer times than the Daily LETF (11 versus 251), longer-term returns showed substantially zero difference. This is because they are governed by the same leverage regulator, just implemented at different intervals.

In light of this, the method of the present disclosure shows unexpected results related to its performance. Because the Hysteresis Regulator of the first embodiment is evaluated daily as part of monitoring, each individual rebalancing action of the Hysteresis MLIIP is on average of substantially the same magnitude as that of a Daily LETF. With an annual average of fewer than 10 daily-sized rebalancing actions, the Hysteresis MLIIP acts on market moves and not a calendar. The ability of the Hysteresis MLIIP to take advantage of stochastic behavior manifested in the underlying index represents an unexpected interaction of variables. Given the efficiency with which the performance improvement over prior art LIIPs is effected, the method of the present disclosure is demonstrated to differ from prior art in kind.

### ADDITIONAL EMBODIMENTS

In accordance with another embodiment, the method of structuring an MLIIP comprises incorporating financing costs. As the method of the present disclosure allows for deviations from Nominal Leverage, the financing costs associated with a CLIIP will vary according to specification of the Candidate Leverage Regulator and values of the Parameter Vector. This will affect the Pairwise Return Differences and in turn the performance metric values calculated by the Mathematical Norm Function. The user of the method of the present disclosure in accordance with this embodiment selects contemporaneous interest rates representative of borrowing costs and includes these costs in simulations of the CLIIP. A person having ordinary skill in Portfolio Management has the capability of choosing relevant interest rates and calculating borrowing costs.

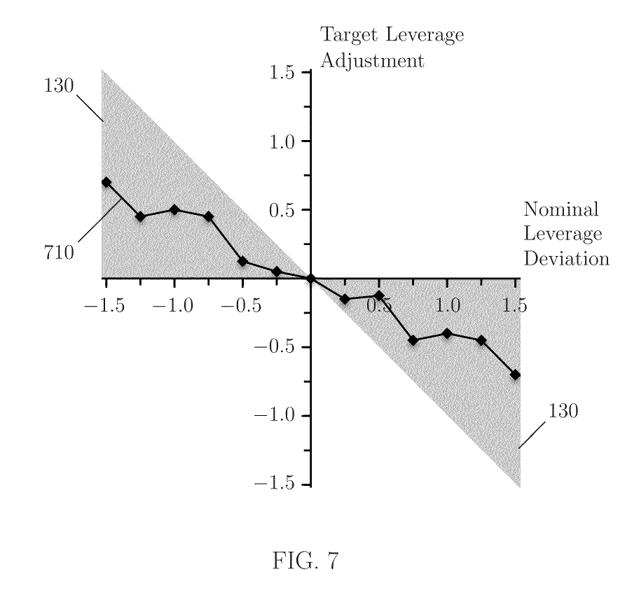

In accordance with another embodiment, the method of structuring an MLIIP comprises specifying a Candidate Leverage Regulator numerically by a vector of parameters. In FIG. 7 is shown an exemplary graph of a candidate for Numerical Regulator 710. The graph shows 13 parameter values over a Nominal Leverage Deviation range of −1.5 to +1.5. The parameter at zero Nominal Leverage Deviation is constrained to be zero. All other parameter values are constrained to remain within Diametric Cone 130. Evaluation between nodes is done by linear interpolation. This embodiment, Numerical Regulator, allows for the method of the present disclosure to be used to determine an MLIIP Regulator without the need to specify the Candidate Leverage Regulator as belonging to any particular family of functions, including but not limited to polynomial, power, exponential, logarithmic, trigonometric, hyperbolic, rational, and logistic.

In accordance with another embodiment, the method of structuring an MLIIP comprises specifying a Candidate Leverage Regulator by a dead-zone function parametrized on index log return. The optimization parameter is index log return. Consider Nominal Leverage equal to +3 as a nonlimiting example. Index log return of +20% will cause leverage to fall from +3 to +2.20. Index log return of −20% will cause leverage to rise from +3 to +5.38. For the optimization parameter value of 0.2, a Candidate Leverage Regulator would impose dead-zone leverage limits of +2.20 and +5.38. Although the minimum and maximum leverage limits do not represent equal-magnitude deviations from Nominal Leverage, the limits are still defined by one parameter as was the case in the first embodiment. This embodiment, Logarithmic Dead-Zone Regulator, allows for symmetrizing performance within a logarithmic return framework.

In accordance with another embodiment, the method of structuring an MLIIP comprises specifying a Candidate Leverage Regulator by a dead-zone function parametrized on two independent parameters specifying the upper and lower limits of the dead-zone region. This embodiment, Two-Dimensional Dead-Zone Regulator, allows for optimizing performance of the MLIIP to the Sample Index Statistical Distribution.

In accordance with another embodiment, the method of structuring an MLIIP comprises using the path of each trajectory to calculate Pairwise Return Differences between a CLIIP and an LRLS. In this embodiment, each daily log return of the CLIIP is compared to that of the LRLS. An Lp norm is calculated for each day across all trajectories, after which another Lp norm is calculated over the daily Lp norms. This is analogous to a vector norm calculated on a dynamic system evolving over time. This embodiment, Path-Dependent Regulator, allows for optimizing performance throughout the Time Interval, not just across it.

In accordance with another embodiment, the method of structuring an MLIIP comprises effecting a positive weighting on Median Return (in place of Mode Return) of the SI Trajectories. The only source of data available for determining statistical parameters consistent with the returns of the underlying index may suffer from statistical bias. Historical data spanning other than a whole number of economic cycles serves as a nonlimiting example of a source of bias in data. This embodiment allows for effecting SI Trajectory weightings robust to statistical bias.

In accordance with another embodiment, the method of structuring an MLIIP comprises application of a Nonnegative Weighting Function to the Sample Index Statistical Distribution. The weighting function is constrained to be nonnegative rather than uniquely positive to allow for preventing selected regions of the Sample Index Statistical Distribution from affecting determination of the Leverage Regulator. The extreme tails of the Sample Index Statistical Distribution serve as nonlimiting examples of such regions. This embodiment also allows for specifying any utility profile deemed to satisfy investor preferences. The method of the present disclosure in accordance with the first embodiment provides guidance sufficient for a person having ordinary skill in Portfolio Management. This embodiment allows for effecting any weighting profile across the distribution of SI Trajectories rather than weighting statistical parameters representative of the entire distribution.

In accordance with another embodiment, the method of maintaining an MLIIP comprises sending to a trader, at a scheduled time each trading day, a message with instructions relating to the rebalancing process. This embodiment allows for streamlining the maintenance process.

In accordance with another embodiment, the method of maintaining an MLIIP comprises sending to an automated trading system, at a scheduled time each trading day, a message with instructions relating to the rebalancing process. This embodiment allows for expediting the maintenance process.

In accordance with another embodiment, the method of maintaining an MLIIP comprises sending to a trader and an automated trading system, at a scheduled time each trading day, a message with instructions relating to the rebalancing process. This embodiment allows for effecting redundancy supportive of a robust system architecture.

### Ramifications

From the preceding description, a number of advantages of one or more embodiments of MLIIPs are evident.

(a) MLIIPs offer improved control of value decay across statistical regimes.

(b) MLIIPs have zero risk of total loss of investor assets.

(c) MLIIPs exhibit no more than a predetermined drift in leverage.

(d) MLIIPs offer investors longer-term returns with advantageous statistical characteristics.

(e) MLIIPs synthesize statistics and market dynamics in an advantageous manner: by efficient use of infrequent and small rebalancing actions, MLIIPs reduce the probability of overwhelming less liquid markets, thereby supporting investor confidence in the integrity of markets.

(f) MLIIPs employ a fund structure in which all shares are fungible, allowing for intraday trading in the open market.

The method of the present disclosure for determining the MLIIP Regulator, monitoring the MLIIP, and rebalancing the MLIIP has the additional advantages in that it supports the following variations.

(a) The Candidate Leverage Regulator may by specified by a function other than dead-zone. Nonlimiting examples of functions include polynomial, power, exponential, logarithmic, trigonometric, hyperbolic, rational, and logistic.

(b) The Time Interval may be other than one year and may be any length satisfying investor preferences. If the Time Interval is of length such that optimization of the Mathematical Norm Function satisfies equilibrium conditions, the MLIIP Regulator will be optimal across all Time Intervals.

(c) The time discretization of the Time Interval of the SI Trajectories may be other than one day.

(d) The number of SI Trajectories may be other than 1000.

(e) SI Trajectory, CLIIP, and LRLS returns over the Time Interval may be calculated using geometric return, a zero-volatility arithmetic return approximating logarithmic return.

(f) The Sample Index Statistical Distribution may be other than normal. Studies suggest markets and cross-sections thereof may exhibit higher-order moments inconsistent with those of a normal distribution. Nonlimiting examples of higher-order moments include third and fourth.

(g) The parameters used for specifying the Sample Index Statistical Distribution may include higher-order parameters in addition to mean and variance. Nonlimiting examples of higher-order parameters include skew and kurtosis.

(h) The Sample Index Statistical Distribution may be specified by arithmetic returns consistent with the underlying index, allowing for all simulations over the Time Interval to be done using a price model based on arithmetic returns.

(i) The Positive Weightings may have relative values other than equal and may have any relative values satisfying investor preferences.

(j) The relative values of the Positive Weightings may be implemented by other than a step-change in the weighting vector. Nonlimiting examples of weighting vector profiles include a triangular peak and a curve.

(k) The weighting of Mode Return may include a percentage of SI Trajectories other than 10%. The weighting of Mode Return may be effected on a single SI Trajectory. The weighting of Mode Return may be effected on a calculated estimate of Mode Return.

(l) The weighting of Median Return may include a percentage of SI Trajectories other than 10%. The weighting of Median Return may be effected on a single SI Trajectory. The weighting of Median Return may be effected on a calculated estimate of Median Return.

(m) The weighting of Mean Average Return may include a percentage of SI Trajectories other than 100%. The weighting of Mean Average Return may be effected on a calculated estimate of Mean Average Return.

(n) The Mathematical Norm Function may be other than the Lₚ norm. Any function satisfying the generally accepted properties associated with norms may be used. A semi-norm, for which the finiteness of homogeneity and the definiteness of nonnegativity are relaxed, serves as a nonlimiting example.

(o) The value of p in the Lₚ norm may be other than 2. Nonlimiting examples of Lₚ norms include L₁ and L_{∞} (L-infinity).

(p) The weighted Lₚ norm may be evaluated on differences of calculated estimates of Mean Average Return and Mode Return rather than a vector of Pairwise Return Differences. The weighted Lₚ norm may be evaluated on differences of calculated estimates of Mean Average Return and Median Return rather than a vector of Pairwise Return Differences.

(q) The Transaction Index may be other than the underlying index. Any assets providing returns substantially the same as those of the underlying index may be used.

(r) Financing costs incorporated in determination of the MLIIP Regulator may make use of interest rates other than contemporaneous. Forecast interest rates serve as nonlimiting examples.

(s) Simulation of a CLIIP tracking SI Trajectories may assume rebalancing is done at a frequency of other than daily and on a schedule of other than near the end of the day.

(t) Data values may be accessed in different ways, including but not limited to retrieval from non-transitory computer-readable media, keyboard input, and online subscription service.

(u) Data values may be provided in different ways, including but not limited to saving to non-transitory computer-readable media, outputting to a display, and electronic message.

(v) Monitoring may be executed on a schedule of other than once per day.

(w) Rebalancing may be executed on a schedule of other than once per day.

(x) The asset exposure of the MLIIP may be evaluated in different ways, including but not limited to the following. If the MLIIP is structured as a fund, the present value of assets in the portfolio of the MLIIP may be used. If the MLIIP is structured as a note—that is to say, it is possible that there are no portfolio assets—the contractual liability of the sponsor may be used. The returns of a basket of assets providing substantially the same returns as those of the underlying index may be used to adjust an earlier, known asset exposure value.

(y) The dimension of the Parameter Vector of the Numerical Regulator may be other than 13. As Portfolio Optimization is a field of study in Finance, a person having ordinary skill in Portfolio Management has the capability of choosing, even if by trial and error, the dimension of the Parameter Vector so as to balance optimization performance and parameter precision. The constraints on the Parameter Vector need not impose symmetry. The constraints on the Parameter Vector need not constrain a node at zero Nominal Leverage Deviation to have a zero value for Target Leverage Adjustment. The constraints on the Parameter Vector need not limit parameters such that they remain within the Diametric Cone.

(z) The Nominal Leverage Deviation range covered by the Parameter Vector of the Numerical Regulator may be other than from −1.5 to +1.5. Depending on Nominal Leverage and index returns, Nominal Leverage Deviation may extend beyond this range (necessitating its expansion) or be well within it (rendering part of the Parameter Vector irrelevant). As Portfolio Optimization is a field of study in Finance, a person having ordinary skill in Portfolio Management has the capability of choosing, even if by trial and error, a suitable range for Nominal Leverage Deviations.

(aa) The embodiment of the Numerical Regulator may be used to identify a function family suitable for the method of structuring an MLIIP. Application of regression techniques to the Parameter Vector values graphed in the two-dimensional space of Target Leverage Adjustment versus Nominal Leverage Deviation allow for identifying a function family. Nonlimiting examples of function families include polynomial, power, exponential, logarithmic, trigonometric, hyperbolic, rational, and logistic. As regression techniques are studied in Finance, a person having ordinary skill in Portfolio Management has the capability of executing this variation.

(ab) Evaluation of the Numerical Regulator between nodes may be done by an interpolation method other than linear. Nonlimiting examples of interpolation methods include polynomial and spline.

### Scope

Further embodiments in accordance with the present disclosure include non-transitory computer-readable media comprising computer-readable instructions to control a computer to perform the steps described herein.

Although multiple embodiments have been described, it should be understood that various modifications and adaptations may be made without deviating from the rationale and purview of the present disclosure. As such, the specification and drawings are to be accepted as exemplifying rather than limiting in nature.

1. A method implemented by a computer for determining a leverage regulator governing a leveraged indexed investment product tracking an underlying index, comprising:
a. specifying a candidate leverage regulator in terms of a parameter vector; and
b. substantially minimizing, by modifying said parameter vector, pairwise return differences between a candidate leveraged indexed investment product and a logarithmic return leveraged system as both are simulated, with said computer, to track a set of sample index trajectories;
c. wherein said candidate leveraged indexed investment product is governed by said candidate leverage regulator;
d. wherein said logarithmic return leveraged system effects nominal leverage;
e. wherein said sample index trajectories span a selected time interval;
f. wherein the sample index trajectories are drawn, with the computer, from a selected sample index statistical distribution;
g. wherein said pairwise return differences are measured by evaluating, with the computer, a selected mathematical norm function;
h. wherein said mathematical norm function effects selected positive weightings on each of mean average return and mode return of the sample index trajectories;
i. wherein said leverage regulator is the candidate leverage regulator specified by the parameter vector that substantially minimized the pairwise return differences over said time interval; and
j. wherein the computer comprises a non-transitory, computer-readable storage medium having computer-executable instructions recorded thereon that, when executed on the computer, configure the computer to perform said method.

2. The method of claim 1, further comprising:
a. accessing, with the computer, value of said leveraged indexed investment product and asset exposure of the leveraged indexed investment product; and based on said values,
b. calculating, with the computer, a nominal leverage deviation of the leveraged indexed investment product;
c. calculating, with the computer, a target leverage adjustment provided by the leverage regulator; and
d. providing, with the computer, said target leverage adjustment.

3. The method of claim 2, further comprising:
a. accessing, with the computer, the target leverage adjustment; and
b. trading, with the computer, units of a selected transaction index to effect the target leverage adjustment.

4. The method of claim 1, wherein the candidate leverage regulator effects hysteresis on said leveraged indexed investment product.

5. The method of claim 4, further comprising:
a. accessing, with the computer, value of the leveraged indexed investment product and asset exposure of the leveraged indexed investment product; and based on said values,
b. calculating, with the computer, a nominal leverage deviation of the leveraged indexed investment product;
c. calculating, with the computer, a target leverage adjustment provided by the leverage regulator; and
d. providing, with the computer, said target leverage adjustment.

6. The method of claim 5, further comprising:
a. accessing, with the computer, the target leverage adjustment; and
b. trading, with the computer, units of a selected transaction index to effect the target leverage adjustment.

7. The method of claim 1, wherein the candidate leverage regulator exists within a diametric cone.

8. The method of claim 7, further comprising:
a. accessing, with the computer, value of said leveraged indexed investment product and asset exposure of the leveraged indexed investment product; and based on said values,
b. calculating, with the computer, a nominal leverage deviation of the leveraged indexed investment product;
c. calculating, with the computer, a target leverage adjustment provided by the leverage regulator; and
d. providing, with the computer, said target leverage adjustment.

9. The method of claim 8, further comprising:
a. accessing, with the computer, the target leverage adjustment; and
b. trading, with the computer, units of a selected transaction index to effect the target leverage adjustment.

10. A method implemented by a computer for determining a leverage regulator governing a leveraged indexed investment product tracking an underlying index, comprising:
a. specifying a candidate leverage regulator in terms of a parameter vector; and
b. substantially minimizing, by modifying said parameter vector, pairwise return differences between a candidate leveraged indexed investment product and a logarithmic return leveraged system as both are simulated, with said computer, to track a set of sample index trajectories;
c. wherein said candidate leveraged indexed investment product is governed by said candidate leverage regulator;
d. wherein said logarithmic return leveraged system effects nominal leverage;
e. wherein said sample index trajectories span a selected time interval;
f. wherein the sample index trajectories are drawn, with the computer, from a selected sample index statistical distribution;
g. wherein said pairwise return differences are measured by evaluating, with the computer, a selected mathematical norm function;
h. wherein said mathematical norm function effects selected positive weightings on each of mean average return and median return of the sample index trajectories;
i. wherein said leverage regulator is the candidate leverage regulator specified by the parameter vector that substantially minimized the pairwise return differences over said time interval; and
j. wherein the computer comprises a non-transitory, computer-readable storage medium having computer-executable instructions recorded thereon that, when executed on the computer, configure the computer to perform said method.

11. The method of claim 10, further comprising:
a. accessing, with the computer, value of said leveraged indexed investment product and asset exposure of the leveraged indexed investment product; and based on said values,
b. calculating, with the computer, a nominal leverage deviation of the leveraged indexed investment product;
c. calculating, with the computer, a target leverage adjustment provided by the leverage regulator; and
d. providing, with the computer, said target leverage adjustment.

12. The method of claim 11, further comprising:
a. accessing, with the computer, the target leverage adjustment; and
b. trading, with the computer, units of a selected transaction index to effect the target leverage adjustment.

13. The method of claim 10, wherein the candidate leverage regulator effects hysteresis on said leveraged indexed investment product.

14. The method of claim 13, further comprising:
a. accessing, with the computer, value of the leveraged indexed investment product and asset exposure of the leveraged indexed investment product; and based on said values,
b. calculating, with the computer, a nominal leverage deviation of the leveraged indexed investment product;
c. calculating, with the computer, a target leverage adjustment provided by the leverage regulator; and
d. providing, with the computer, said target leverage adjustment.

15. The method of claim 14, further comprising:
a. accessing, with the computer, the target leverage adjustment; and
b. trading, with the computer, units of a selected transaction index to effect the target leverage adjustment.

16. The method of claim 10, wherein the candidate leverage regulator exists within a diametric cone.

17. The method of claim 16, further comprising:
a. accessing, with the computer, value of said leveraged indexed investment product and asset exposure of the leveraged indexed investment product; and based on said values,
b. calculating, with the computer, a nominal leverage deviation of the leveraged indexed investment product;
c. calculating, with the computer, a target leverage adjustment provided by the leverage regulator; and
d. providing, with the computer, said target leverage adjustment.

18. The method of claim 17, further comprising:
a. accessing, with the computer, the target leverage adjustment; and
b. trading, with the computer, units of a selected transaction index to effect the target leverage adjustment.

19. A method implemented by a computer for determining a leverage regulator governing a leveraged indexed investment product tracking an underlying index, comprising:
a. specifying a candidate leverage regulator in terms of a parameter vector; and
b. substantially minimizing, by modifying said parameter vector, pairwise return differences between a candidate leveraged indexed investment product and a logarithmic return leveraged system as both are simulated, with said computer, to track a set of sample index trajectories;
c. wherein said candidate leveraged indexed investment product is governed by said candidate leverage regulator;
d. wherein said logarithmic return leveraged system effects nominal leverage;
e. wherein said sample index trajectories span a selected time interval;
f. wherein the sample index trajectories are drawn, with the computer, from a selected sample index statistical distribution;
g. wherein said pairwise return differences are measured by evaluating, with the computer, a selected mathematical norm function;
h. wherein said mathematical norm function effects a selected nonnegative weighting function on said sample index statistical distribution;
i. wherein said leverage regulator is the candidate leverage regulator specified by the parameter vector that substantially minimized the pairwise return differences over said time interval; and
j. wherein the computer comprises a non-transitory, computer-readable storage medium having computer-executable instructions recorded thereon that, when executed on the computer, configure the computer to perform said method.

20. The method of claim 19, further comprising:
a. accessing, with the computer, value of said leveraged indexed investment product and asset exposure of the leveraged indexed investment product; and based on said values,
b. calculating, with the computer, a nominal leverage deviation of the leveraged indexed investment product;
c. calculating, with the computer, a target leverage adjustment provided by the leverage regulator; and
d. providing, with the computer, said target leverage adjustment.

21. The method of claim 20, further comprising:
a. accessing, with the computer, the target leverage adjustment; and
b. trading, with the computer, units of a selected transaction index to effect the target leverage adjustment.

22. The method of claim 19, wherein the candidate leverage regulator effects hysteresis on said leveraged indexed investment product.

23. The method of claim 22, further comprising:
a. accessing, with the computer, value of the leveraged indexed investment product and asset exposure of the leveraged indexed investment product; and based on said values,
b. calculating, with the computer, a nominal leverage deviation of the leveraged indexed investment product;
c. calculating, with the computer, a target leverage adjustment provided by the leverage regulator; and
d. providing, with the computer, said target leverage adjustment.

24. The method of claim 23, further comprising:
a. accessing, with the computer, the target leverage adjustment; and
b. trading, with the computer, units of a selected transaction index to effect the target leverage adjustment.

25. The method of claim 19, wherein the candidate leverage regulator exists within a diametric cone.

26. The method of claim 25, further comprising:
a. accessing, with the computer, value of said leveraged indexed investment product and asset exposure of the leveraged indexed investment product; and based on said values,
b. calculating, with the computer, a nominal leverage deviation of the leveraged indexed investment product;
c. calculating, with the computer, a target leverage adjustment provided by the leverage regulator; and
d. providing, with the computer, said target leverage adjustment.

27. The method of claim 26, further comprising:
a. accessing, with the computer, the target leverage adjustment; and
b. trading, with the computer, units of a selected transaction index to effect the target leverage adjustment.
